(19) United States
(12) Patent Application Publication
(10) Pub. No.: US 2013/0056641 A1
(43) Pub. Date: Mar. 7, 2013

(54) SOLID-STATE NEUTRON DETECTOR WITH GADOLINIUM CONVERTER

(71) Applicants: Steven A. Vitale, Waltham, MA (US); Pascale Gouker, Lexington, MA (US)

(72) Inventors: Steven A. Vitale, Waltham, MA (US); Pascale Gouker, Lexington, MA (US)

(73) Assignee: Massachusetts Institute of Technology, Cambridge, MA (US)

(21) Appl. No.: 13/488,558

(22) Filed: Jun. 5, 2012

Related U.S. Application Data
(60) Provisional application No. 61/529,948, filed on Sep. 1, 2011.

(51) Int. Cl. G01T 3/08

(52) U.S. Cl. 250/370.05

(57) ABSTRACT

Thermal Neutron Detector. The detector includes at least one semiconductor transistor within a circuit for monitoring current flowing through the semiconductor transistor. A film of gadolinium-containing material covers the semiconductor transistor whereby thermal neutrons interacting with the gadolinium-containing material generate electrons that induce a change in current flowing through the semiconductor transistor to provide neutron detection.

This application claims priority to U.S. provisional application No. 61/529948 filed on Sept. 1, 2011, the contents of which are incorporated herein by reference.

This invention was made with government support under Grant No. FA8721-05-C-0002 awarded by the U.S. Air Force. The government has certain rights in this invention,

### BACKGROUND OF THE INVENTION

This invention relates to a solid-state thermal neutron detector that enables practical, hand-held, low-power and low cost thermal neutron detection.

Neutron detection is used to detect nuclear materials such as, for example, ²⁴⁰Pu that might be transported illegally through airports, border crossings and other points of entry. Neutrons are difficult to detect, however, because they are uncharged particles. Their cross section for reaction with most materials is very small, so they pass through most detectors without leaving any signature.

Gaseous ionization neutron detectors are known and are used in portal monitors. Such ionization detectors use ³He gas, an extremely rare material. The entire United States stockpile of ³He may be depleted by 2015 according to a recent Congressional study, at which time it will no longer be possible to build new gaseous ionization neutron detectors. Further, gaseous ionization technology for thermal neutron detection is physically large, power-hungry and expensive.

An object of the present invention, therefore, is a solid state thermal neutron detector that does not rely on the rare ³He resource, and can be fabricated to be as small as a conventional microchip thereby allowing order of magnitude reduction in size, weight, power and cost over traditional gaseous ionization detectors.

### SUMMARY OF THE INVENTION

The thermal neutron detector, according to the invention, includes at least one semiconductor transistor within a circuit for monitoring current flowing through the semiconductor transistor, A film of gadolinium-containing material (e.g., gadolinium oxide Gd₂O₃) is provided to cover the semiconductor transistor whereby thermal neutrons interacting with the gadolinium-containing material generate electrons that induce a change in current flowing through the semiconductor transistor to provide neutron detection. In a preferred embodiment, an array of semiconductor transistors is utilized. It is also preferred that the film be deposited on the semiconductor transistor by plasma-enhanced atomic layer deposition.

### BRIEF DESCRIPTION OF THE DRAWING

FIG. 1 is a schematic illustration of an embodiment of a transistor-based thermal neutron detector disclosed herein.

FIG. 2 is a schematic illustration of an embodiment of a CCD- or diode-based thermal neutron counter according to the invention.

FIG. 3 is a graph of normalized current versus time for PMOS transistors with and without a gadolinium oxide coating with neutrons on and off.

FIG. 4 is a graph of normalized current, versus time for NMOS transistors with and without a gadolinium oxide coating with neutrons on and off.

### DESCRIPTION OF THE PREFERRED EMBODIMENT

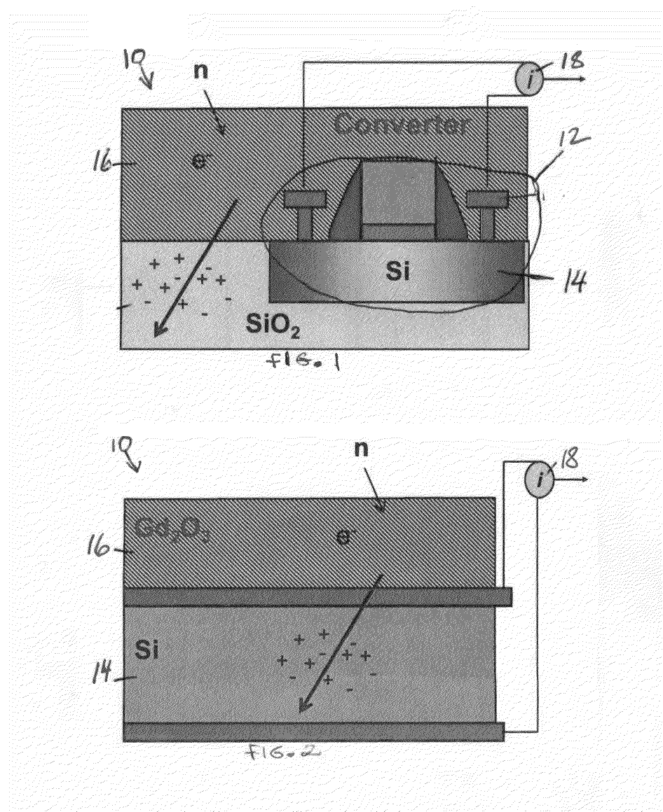

With reference to FIG. 1, a thermal neutron detector 10 includes an array of semiconductor transistors 12 in semiconductor detecting material 14. The transistors 12 are covered by a film 16 of gadolinium oxide, Gd₂O₃. It is preferred that the semiconductor transistors 12 be very sensitive microfabricated devices.

It is to be noted that any film containing gadolinium will work. However, the gadolinium-containing film must he insulating so that gadolinium metal itself cannot be used unless it is separated from the semiconductor detectors by an insulating layer. An advantage of Gd₂O₃ is that it is semiconductor fabrication compatible, in that it does not contain incompatible elements (e.g., alkali metals or gold), and it is stable during subsequent high temperature processing (up to at least 400° C.). Other gadolinium-containing materials with these characteristics (e.g., gadolinium nitride) will work.

The gadolinium oxide film 16 serves as a converter layer to generate high-energy electrons by a nuclear reaction between thermal neutrons and the gadolinium atoms. These high-energy electrons, in turn, induce a shift in the current flowing through the semiconductor transistors 12, thus producing a detectible signature indicating that a neutron had passed into the film 16. A detector 18 is used to monitor the change in current through the transistors 12.

It is preferred that the gadolinium oxide film 16 be deposited by a method that is completely compatible with existing methods of commercial transistor fabrication, such as by plasma-enhanced atomic layer deposition. This compatibility with existing methods implies that low-cost gadolinium oxide-based neutron detectors can be easily integrated with other integrated circuits for advanced signal analysis and other complex functions in a small form factor device as is needed for multiple commercial and military applications.

Another embodiment of the invention is shown in FIG. 2. The embodiment in FIG. 2 is a CCD- or diode-based device that counts individual current pulses. The embodiment of FIG. 2 can provide spectral information about the energy of the conversion electrons from detected thermal neutrons.

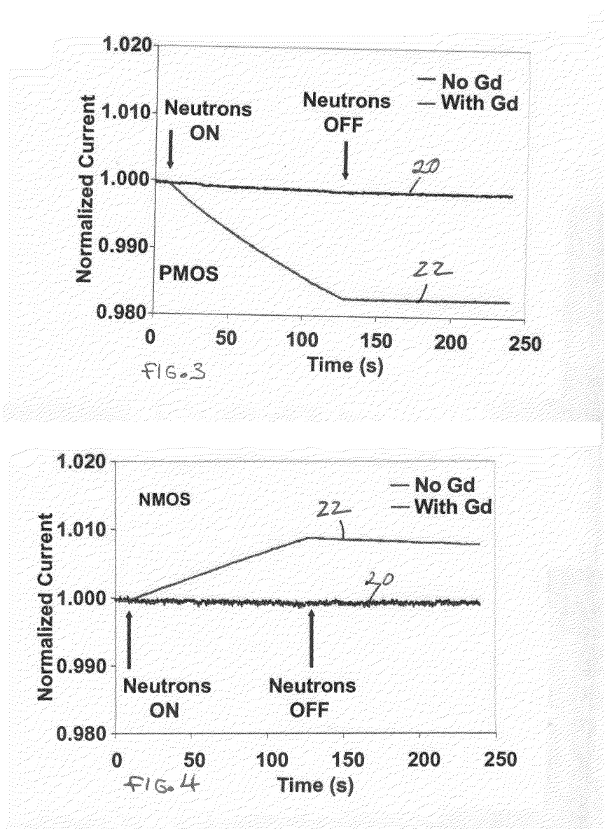

Experiments have been conducted at the MIT Lincoln Laboratory comparing Gd₂O₃-coated silicon transistors with identical uncoated silicon transistors. Current through the transistors was measured before, during and after exposure to a thermal neutron beam. As shown in FIG. 3, uncoated PMOS transistors show no change in current 20 during neutron irradiation. However, the Gd₂O₃-coated transistors show a decrease in current 22. Thus, the passage of neutrons is readily detected. Similarly, as shown in FIG. 4, uncoated NMOS transistors show no change in current 20 during neutron irradiation while the coated transistors show an increase in current 22.

Because there are no existing commercial solid-state neutron detectors, the present invention will be unique in the marketplace. Nearly all applications currently served by gaseous ionization detectors can be replaced with the solid-state neutron detector disclosed herein. Applications include cargo inspection and might be included on the inside or outside of shipping containers to detect neutron radiation from the contents. Portable systems will find application for compliance monitoring, such as to monitor disarmament activities, detect nuclear reactor fuel storage or processing, or transport of nuclear materials. Very small devices can be worn by personnel to serve as radiation protection monitors. The solid-state neutron detector disclosed herein can also be used in medical diagnostics, such as neutron tomography. Scientific instruments can benefit as well, employing solid-state neutron detectors for materials analysis by neutron scattering and as coincidence detectors in high energy physics experiments.

### EXAMPLE

Fully depleted silicon on insulator (FDSOI) transistors were fabricated in a conventional way. Control devices without the Gd₂O₃ coating and neutron detection devices with approximately 1 μm of PE-ALD Gd₂O₃ coating were fabricated. Four transistor types (NMOS & PMOS/Width=8 μm & 2000 μm) were packaged and assembled onto a custom circuit board, and the test programs were written on an HP4155 Parametric Analyzer. After test verification, the setup was moved to the MIT Reactor Lab where experiments were performed in the thermal neutron radiation facility. The thermal neutron flux was estimated to be 4.77×10⁹/cm²-s based on activation of a gold foil measured by the Reactor Lab staff. The live testing first consisted of measuring transistor I-V curves before irradiation, and after irradiation periods of 30 s, 90 s, and 300 s. These tests showed that neither the Gd-coated nor the uncoated devices were damaged by the neutron radiation. Then, the on-current of the devices was measured at constant voltage for a period of 4 minutes, during which time the neutron beam was off for 10 seconds, on for 120 seconds, then off for 110 seconds. The chip was then replaced with a second one, arid the testing repeated for verification. The Gd₂O₃-coated devices showed a clear change in current during the neutron irradiation, whereas the uncoated devices measured simultaneously in the same neutron flux environment showed no response. This is the expected and desired result, that the control devices without Gd coating are not sensitive to thermal neutrons, but the Gd₂O₃-coated devices are sensitive.

It is recognized that modifications and variations of the present invention will he apparent to those of ordinary skill in the art and it is intended that all such modifications and variations be included within the scope of the appended claims.

What is claimed is:

1. Thermal neutron detector comprising:
at least one semiconductor transistor within a circuit for monitoring current flowing through the semiconductor transistor; and
a gadolinium-containing film covering the semiconductor transistor, whereby thermal neutrons interacting with the gadolinium-containing film generate electrons that induce a change in current flowing through the semiconductor transistor to provide neutron detection.

2. The neutron detector of claim 1 including an array of semiconductor transistors.

3. The neutron detector of claim 1 wherein the film is deposited on the transistor in a commercially-available silicon CMOS-compatible way.

4. The neutron detector of claim 1 wherein the detector is portable.

5. The neutron detector of claim 1 wherein the film is gadolinium oxide.

6. The neutron detector of claim 3 wherein the deposition is by plasma-enhanced atomic layer deposition.
